(19) United States
(12) Patent Application Publication
(10) Pub. No.: US 2006/0174035 A1
(43) Pub. Date: Aug. 3, 2006

(54) System, device, & method for applying COS policies

(75) Inventor: Mudassir Tufail, Freehold New Jersey, NJ (US)

Correspondence Address: AT&T Corp., Room 2A-207, One AT&T Way, Bedminster, NJ, 07921, US

(73) Assignee: AT&T Corp.

(21) Appl. No.: 11/045,818

(22) Filed: Jan. 28, 2005

(51) Int. Cl. G06F 15/173

(52) U.S. Cl. 709/239

(57) ABSTRACT

Certain exemplary embodiments comprise a method, comprising: in a BGP network comprising a plurality of neighbors: associating a desired COS policy for a specified interface with a BGP community value; and providing a BGP update message comprising the BGP community value.

### BACKGROUND

Border Gateway Protocol (BGP) is the most commonly used Internet backbone protocol, and is designed to ensure that data gets to its destination network regardless of current network conditions. The algorithm of BGP tends to provide strong network stability, and can essentially guarantee that if one network connection goes down, the network can quickly adapt to send packets through another connection.

Within the world of BGP, those routers (and/or other entities having routing capability) under a single point of administrative control are typically referred to as an Autonomous System (AS). Typically, protocols designed to route within an autonomous system don't carry policy information, other than possibly packet classification policy.

Class of Service (COS) is a form of priority queuing that can provide a way of classifying and prioritizing packets based on application type (e.g., voice, video, file transfers, and/or transaction processing, etc.), the type of user (e.g., CEO, secretary, and/or sales engineer, etc.), and/or other settings. COS can classify packets by examining packet parameters and/or COS markings and/or can place packets in queues of different priorities based on predefined criteria. Low-priority traffic can be “drop eligible,” while high-priority traffic can get the best available service.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a block diagram of an exemplary embodiment of an information device 2000;

FIG. 3 is a flowchart of an exemplary embodiment of a method 3000; and

FIG. 4 is a flowchart of an exemplary embodiment of a method 4000.

### DETAILED DESCRIPTION

Border Gateway Protocol (BGP) is the most commonly used Internet backbone protocol, and is designed to ensure that data gets to its destination network regardless of current network conditions. The algorithm of BGP tends to provide strong network stability, and can essentially guarantee that if one network connection goes down, the network can quickly adapt to send packets through another connection.

Within the world of BGP, those routers (and/or other entities having routing capability) under a single point of administrative control are typically referred to as an Autonomous System (AS). Typically, protocols designed to route within an autonomous system don't carry policy information, other than possibly packet classification policy.

Class of Service (COS) is a form of priority queuing that can provide a way of classifying and prioritizing packets based on application type (e.g., voice, video, file transfers, and/or transaction processing, etc.), the type of user (e.g., CEO, secretary, and/or sales engineer, etc.), and/or other settings. COS can classify packets by examining packet parameters and/or COS markings and/or can place packets in queues of different priorities based on predefined criteria. Low-priority traffic can be “drop eligible,” while high-priority traffic can get the best available service.

Policy-based management can provide a way to allocate network resources, such as network bandwidth, Quality of Service (QoS), and/or security, etc., according to defined business policies, and thus can identify how network users and/or network devices can access network resources. For example, as the desire for QoS increases with the use of Voice over IP (VoIP) and other real-time applications, the desire can increase for policy-based bandwidth allocation.

Policy definitions can respond to questions such as:
Who and what can access which resources on the network?
What is the highest priority traffic, what is the lowest priority traffic, and what levels of traffic are in between?
What traffic must have guaranteed delivery?
How is bandwidth allocated to ensure guaranteed delivery?
What traffic is eligible for discard when the network becomes busy and congested?

A policy-based management system can allow administrators to define rules based on these types of questions and/or manage them in the policy system. A condition can be any of a wide variety of items, such as a user or group, the time of day, the application type, and/or the network address, etc.

BGP attributes are an array of information carried in a BGP update capable of indicating anything from path preference to various additional pieces of information about a route, either within an autonomous system or outside an autonomous system.

The BGP community path attribute is an optional transitive attribute. The attribute typically comprises a set of four octet values. The community attribute values can be encoded using an AS number in the first two octets. The remaining two octets can be defined by the AS administrator. The community value can be used for multiple purposes such as route-filtering, internet gateway selection, and/or local-preference, etc. A community is a group of destinations (i.e., prefixes) that share some common attribute. Each destination/prefix can belong to multiple communities. The BGP community can allow one to group a set of prefixes and/or perform routing decisions based on the identity (which is the community value) of the group.

As mentioned above, a common use of the BGP community attribute is to perform some specific routing decisions. The BGP community values can be used, however, for other purposes as well.

In certain novel approaches, a customer (“neighbor” in BGP parlance) can automatically and/or dynamically set and/or modify a COS service policy via providing a BGP update message comprising (a pre-defined) community value. This community value can map to a desired COS service policy. Upon receipt of the BGP update message, an AS management entity (e.g., a router operating system) can update the customer's COS policy to reflect a desired COS policy referenced in the received BGP update message. The sent community values can comprise an IP address (which can indicate an interface) where the desired COS policy and/or its rules are to be applied. Different community values and/or portions thereof can be utilized for ingress policies vs. egress policies. Typically, the customer interfaces on a provider's edge router will start up with default policy and a customer could then over-write them (by sending the BGP update with an appropriate BGP community value) with a policy that meets the COS needs for the set of applications running at that time.

The ability for a customer to dynamically and/or automatically modify a COS policy can reduce manual and/or administrative burdens on the customer and/or the service provider. Additionally, the customer can control in real-time the COS behavior on its interfaces on provider edge routers. Since a set of applications can change (from day to night and/or weekday to weekend, etc), it can be very useful for customers to be able to control in real-time the COS behavior on their interfaces on each provider edge router.

Thus, certain exemplary embodiments comprise a method, comprising: in a BGP network comprising a plurality of neighbors: associating a desired COS policy for a specified interface with a BGP community value; and providing a BGP update message comprising the BGP community value.

Certain exemplary embodiments comprise a method, comprising: in a BGP network comprising a plurality of neighbors: receiving a BGP update message comprising a BGP community value associated with a desired COS policy and comprising an IP address that refers to an interface where the desired COS policy is to be applied; and based on the received BGP update message, automatically changing from an operative COS policy to the desired COS policy on the interface.

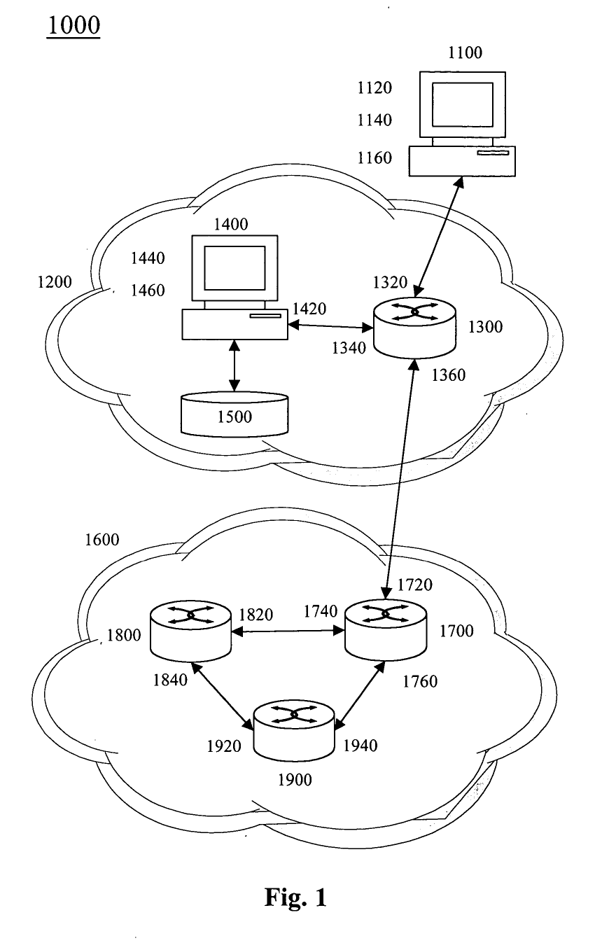

FIG. 1 is a block diagram of an exemplary embodiment of a system 1000, which can comprise a customer information device 1100 coupled to a network 1200 via an interface 1320 of a router 1300. Within network 1200, router 1300 can be coupled to other entities, such as other routers and/or server 1400. Likewise, router 1300 can be coupled to entities of other networks, such as router 1700 of network 1600.

Customer information device 1100 can comprise a client program 1120 that utilizes a browser 1140 to define a COS policy 1160 that can be applied to an interface of an element of a network, such as, for example interface 1320 of router 1300 of network 1200. Via interface 1340, router 1300 can be coupled to interface 1420 of server 1400, which can comprise a server program 1440 and/or a database management program 1460. Server 1400 can be coupled to a database 1500, which can store COS policies for application to interfaces as desired.

Via interface 1360, router 1300 can be coupled to a second network 1600 via interface 1720 of router 1700. Within network 1600, router 1700 can be coupled via interface 1740 to interface 1820 of router 1800 and/or via interface 1760 to interface 1940 of router 1900. Likewise, router 1800 can be coupled via interface 1840 to interface 1920 of router 1900.

To any interface of any entity can be applied a COS policy. The COS policy can be, for example, a default COS policy, and/or a desired COS policy, etc. The interface can be identified via its address, such as its IP address. The COS policy can be applied to the interface via a BGP update message. That is, a BGP update message can comprise a BGP community value that indicates a desired COS policy and/or an interface to which to apply that policy. Thus, if an operative COS policy is determined to not be a desired COS policy, the desired COS policy, as indicated by and/or in the BGP community value, can be obtained and applied to the interface to replace the operative COS policy. The BGP community value can be a standard community value and/or an extended community value. The BGP community value need not be and/or is not utilized to perform a specific routing decision. The BGP community value can comprise an Autonomous System identifier.

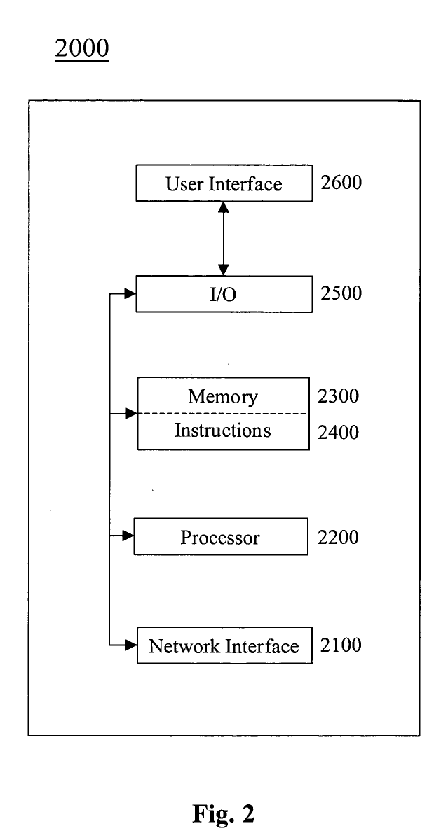

FIG. 2 is a block diagram of an exemplary embodiment of an information device 2000, which in certain operative embodiments can comprise, for example, server customer information device 1100, router 1300, 1700, 1800, 1900, and/or server 1400, etc. of FIG. 1. Information device 2000 can comprise any of numerous well-known components, such as for example, one or more network interfaces 2100, one or more processors 2200, one or more memories 2300 containing instructions 2400, one or more input/output (I/O) devices 2500, and/or one or more user interfaces 2600 coupled to I/O device 2500, etc.

In certain exemplary embodiments, via one or more user interfaces 2600, such as a graphical user interface, a user can view a rendering of, and/or information related to, a COS policy, such as an ingress policy and/or an egress policy, etc.

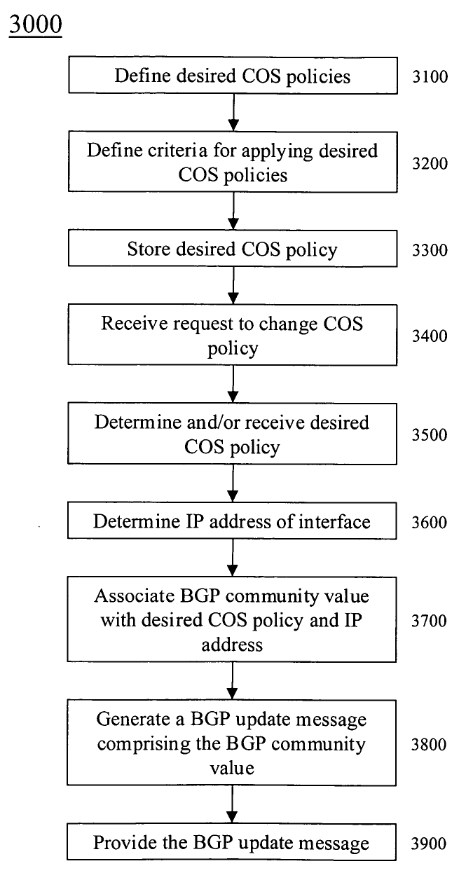

FIG. 3 is a flowchart of an exemplary embodiment of a method 3000. At activity 3100, desired COS policies can be defined. At activity 3200, criteria for applying each desired COS policy can be defined. At activity 3300, the desired COS policies and/or application criteria can be stored. At activity 3400, a request can be received to change a COS policy on a specified interface. At activity 3500, a desired COS policy can be determined, obtained, and/or received. At activity 3600, an address, such as an IP address, of the interface on which to apply the desired COS policy can be determined, obtained, and/or received. At activity 3700, the desired COS policy and the address of the interface can be associated with a BGP community value. At activity 3800, a BGP update message comprising the BGP community value can be generated. At activity 3900, the BGP update message can be provided to a network, network resource, network entity, router, and/or interface, etc.

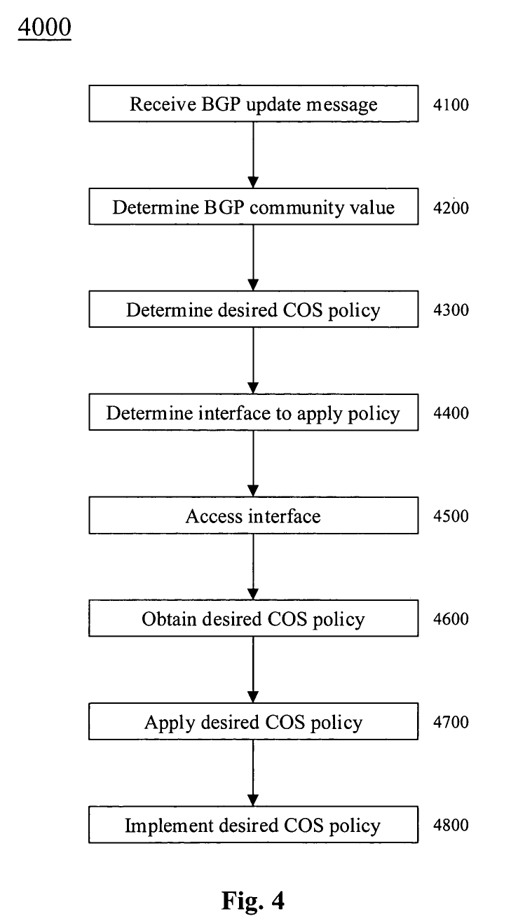

FIG. 4 is a flowchart of an exemplary embodiment of a method 4000. At activity 4100, a BGP update message can be received, obtained, and/or determined. At activity 4200, a BGP community value can be determined, interpreted, and/or obtained from the BGP update message. At activity 4300, a desired COS policy can be determined, interpreted, and/or obtained from the BGP community value. At activity 4400, an address of an interface to which to apply the desired COS policy can be determined, interpreted, and/or obtained from the BGP community value. At activity 4500, the desired COS policy can be obtained. At activity 4600, the interface can be accessed. At activity 4700, the desired COS policy can be applied to the interface. At activity 4800, the desired COS policy can be implemented on the interface.

When the following terms are used herein, the accompanying definitions apply:
access—to approach, enter, exit, communicate with, or make use of.
activity—an action, act, step, and/or process or portion thereof.
adapted to—made suitable or fit for a specific use or situation.
address—symbols, characters, names, and/or numbers used for identification in information transmission, storage, and/or retrieval that are assignable to a specific machine, component, interface, and/or circuit.
apparatus—an appliance or device for a particular purpose
apply—to implement.
associate—to relate, map, and/or join together.
automatically—acting or operating in a manner essentially independent of external influence or control. For example, an automatic light switch can turn on upon “seeing” a person in its view, without the person manually operating the light switch.
Autonomous System (AS)—a network or group of networks under a common administration and with common routing policies.
Autonomous System management entity—a router operating system.
BGP (Border Gateway Protocol)—a routing protocol that 1) runs over TCP; 2) is used to exchange routing information for the Internet; 3) is the routing protocol typically used between Autonomous Systems, such as Internet service providers (ISPs), and 4) is presently defined by the current version of RFC 1771.
BGP attribute—a property of a BGP update message and capable of indicating anything from path preference to information about a route.
BGP community—a group of destinations (i.e., routing number prefixes) that share some common attribute.
BGP community value—information associated with a BGP community attribute, and typically presented as a set of four octet values in which an AS number occupies the first two octets, with the remaining two octets defined by the AS administrator. The community value can be used for multiple purposes, such as route-filtering, internet gateway selection, and/or local-preference, etc.
BGP network—an AS that utilizes BGP.
BGP update message—one of several types of communications from one BGP router to one or more neighbors, and which can be used to exchange routing information such as information about a withdrawn route and/or a new preferred route for an IP address.
BGP value—information corresponding to a BGP attribute.
can—is capable of, in at least some embodiments.
change—to cause to be different.
comprising—including but not limited to.
COS (Class of Service)—a form of priority queuing that provides a way of classifying and prioritizing packets based on application type (voice, video, file transfers, transaction processing), the type of user (CEO, secretary), and/or other settings. COS typically classifies packets by examining packet parameters or COS markings and placing packets in queues of different priorities based on predefined criteria. Typically, low-priority traffic is “drop eligible,” while high-priority traffic gets the best available service.
couplable—capable of being joined, connected, and/or linked together.
data—distinct pieces of information, usually formatted in a special or predetermined way and/or organized to express concepts.
define—to precisely and/or distinctly describe and/or specify.
desired—indicated, expressed, and/or requested.
determine—ascertain, obtain, and/or calculate.
egress—pertaining to packets that are exiting a given router and/or network.

extended community value—a community value comprising more than 4 octets.
generate—to create or produce.
ingress—pertaining to packets that are entering a given router and/or network.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instructions—directions adapted to perform a particular operation or function.
interface—a addressable device for communicatively coupling an entity (such as a router, server, switch, softswitch, gateway, etc.) to a packet network, the addressable device comprising hardware, firmware, and/or software, etc. The entity can have multiple interfaces, each of which can be addressable via one or more packet networks.
Internet Protocol (IP)—a network protocol that specifies the format of packets, also called datagrams, and the addressing scheme for the packets. By itself, IP is a protocol for providing a message from a source to a network, but does not establish a direct link between the source and the destination. TCP/IP, on the other hand, can establish a connection between two communicators so that they can send messages back and forth for a period of time.
machine readable medium—a physical structure from which a machine can obtain data and/or information. Examples include a memory, punch cards, etc.
may—is allowed to, in at least some embodiments.
memory—a device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory can be coupled to a processor and can store instructions adapted to be executed by processor according to an embodiment disclosed herein.
method—a process, procedure, and/or collection of related activities for accomplishing something.
neighbor—a router within a short distance or interval in space or time from a given router and with no intervening routers.
network—a communicatively coupled plurality of nodes.
network interface—any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.
operative—being in effect; operating.
plurality—the state of being plural and/or more than one.
policy—a set of rules, typically in an “If X, then Y” format, defining and/or governing how network users, applications, systems, and/or devices can access and/or use network resources. A policy can provide answers to questions such as:
   1. Who and what can access which resources on the network?
   2. What is the highest priority traffic, what is the lowest priority traffic, and what levels of traffic are in between?
   3. What traffic must have guaranteed delivery?
   4. How is bandwidth allocated to ensure guaranteed delivery?
   5. What traffic is eligible for discard when the network becomes busy and congested?
predetermined—established in advance.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
provide—to make available; to supply; to prepare.
receive—to take, obtain, and/or acquire.
rule—an expression, typically in “If X, then Y” format, that can control an outcome (e.g., Y) based on a particular input (e.g., X).
store—to place, hold, and/or retain data, typically in a memory.
substantially—to a great extent or degree.
system—a collection of mechanisms, devices, data, and/or instructions, the collection designed to perform one or more specific functions.
telecommunications—the science and technology of communication at a distance by electronic transmission of impulses.
transmit—to send.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A method, comprising:
in a BGP network comprising a plurality of neighbors:
associating a desired COS policy for a specified interface with a BGP community value; and
providing a BGP update message comprising the BGP community value.

2. The method of claim 1, further comprising:
determining the desired COS policy.

3. The method of claim 1, further comprising:
determining criteria for applying the desired COS policy.

4. The method of claim 1, further comprising:
determining the BGP community value.

5. The method of claim 1, further comprising:
generating the BGP update message.

6. The method of claim 1, wherein:
the BGP update message is provided to an Autonomous System management entity.

7. The method of claim 1, wherein:
the BGP community value comprises an address of the specified interface where the desired COS policy is to be applied.

8. A method, comprising:
in a BGP network comprising a plurality of neighbors:
receiving a BGP update message comprising a BGP community value associated with a desired COS policy and comprising an IP address that refers to an interface where the desired COS policy is to be applied; and
based on the received BGP update message, automatically changing from an operative COS policy to the desired COS policy on the interface.

9. The method of claim 8, further comprising:
based on the received BGP community value, determining the desired COS policy.

10. The method of claim 8, further comprising:
accessing the desired COS policy.

11. The method of claim 8, further comprising:
based on the received BGP community value, determining the IP address value of the interface.

12. The method of claim 8, further comprising:
accessing the interface.

13. The method of claim 8, further comprising:
implementing the desired COS policy on the interface.

14. The method of claim 8, wherein:
the BGP update message is received by an Autonomous System management entity.

15. The method of claim 8, wherein:
the BGP community value is not utilized to perform a specific routing decision.

16. The method of claim 8, wherein:
the BGP community value is an extended community value.

17. The method of claim 8, wherein:
the BGP community value is a standard community value.

18. The method of claim 8, wherein:
the desired COS policy comprises a plurality of rules governing use of network resources.

19. A machine readable medium storing instructions for activities comprising:
in a BGP network comprising a plurality of neighbors:
associating a desired COS policy for a specified interface with a BGP community value; and
providing a BGP update message comprising BGP the community value.

20. A machine readable medium storing instructions for activities comprising:
in a BGP network comprising a plurality of neighbors:
receiving a BGP update message comprising a BGP community value associated with a desired COS policy and comprising an IP address that refers to an interface where the desired COS policy is to be applied; and
based on the received BGP update message, automatically updating an operative COS policy to the desired COS policy on the interface.
